(19) United States
(12) Patent Application Publication
(10) Pub. No.: US 2026/0341079 A1
(43) Pub. Date: Oct. 29, 2026

(54) DETECTION DEVICE, DETECTION SYSTEM, DETECTION METHOD, AND DETECTION PROGRAM

(71) Applicants: SUMITOMO ELECTRIC INDUSTRIES, LTD., Osaka-shi, Osaka (JP); AUTONETWORKS TECHNOLOGIES, LTD., Yokkaichi-shi, Mie (JP); SUMITOMO WIRING SYSTEMS, LTD., Yokkaichi-shi, Mie (JP); TOYOTA JIDOSHA KABUSHIKI KAISHA, Toyota-shi, Aichi (JP)

(72) Inventors: Kentarou TAKAKI, Osaka-shi, Osaka (JP); Junji YANO, Osaka-shi, Osaka (JP); Tomoyuki MURAYOSHI, Osaka-shi, Osaka (JP); Isao WATANABE, Nagoya-shi, Aichi (JP)

(73) Assignees: SUMITOMO ELECTRIC INDUSTRIES, LTD., Osaka-shi, Osaka (JP); AUTONETWORKS TECHNOLOGIES, LTD., Yokkaichi-shi, Mie (JP); SUMITOMO WIRING SYSTEMS, LTD., Yokkaichi-shi, Mie (JP); TOYOTA JIDOSHA KABUSHIKI KAISHA, Toyota-shi, Aichi (JP)

(21) Appl. No.: 19/119,773

(22) PCT Filed: Sep. 7, 2023
(86) PCT No.: PCT/JP2023/032743

§ 371 Date: Apr. 10, 2025

(30) Foreign Application Priority Data
Oct. 11, 2022 (JP) 2022-163477

(51) Int. Cl. G07C 5/00; G07C 5/08; G08G 1/00; G08G 1/017

(52) U.S. Cl. CPC G07C 5/008; G07C 5/0808; G07C 5/0816; G07C 5/0841; G08G 1/017; G08G 1/20

(57) ABSTRACT

A detection device includes: a first acquisition unit configured to acquire, from a vehicle, vehicle information regarding the vehicle, the vehicle information including identification information of the vehicle; a second acquisition unit configured to acquire a collection record of the vehicle information acquired by the first acquisition unit; a third acquisition unit configured to acquire an operation plan for the vehicle corresponding to the identification information; and a detection unit configured to detect an abnormality related to the vehicle, based on the collection record and the operation plan.

### TECHNICAL FIELD

The present disclosure relates to a detection device, a detection system, a detection method, and a detection program.

This application claims priority on Japanese Patent Application No. 2022-163477 filed on Oct. 11, 2022, the entire content of which is incorporated herein by reference.

### BACKGROUND ART

Japanese Laid-Open Patent Publication No. 2008-216113 (Patent Literature 1) discloses a malfunction information aggregation system as follows. That is, a malfunction information aggregation system aggregates malfunction information of vehicles at a center.

Each vehicle includes: a vehicle traveling information acquisition means that acquires vehicle traveling information as data regarding the traveling state of the vehicle; a vehicle traveling information transmission means that transmits the vehicle traveling information to the center; a voice call means that enables a call between a driver of the vehicle and an operator at the center; and a control means that, based on an instruction of the driver, causes the vehicle traveling information transmission means to start transmission of the vehicle traveling information to the center, and causes the voice call means to start a voice call with the operator. The center includes: a vehicle traveling information reception means that receives the vehicle traveling information transmitted from the vehicle; a voice call means that enables a call between the driver of the vehicle and the operator at the center; and a malfunction information storage means that stores therein the received vehicle traveling information in association with the content of the malfunction notified from the driver of the vehicle through the voice call means.

Japanese Laid-Open Patent Publication No. 2014-081390 (Patent Literature 2) discloses a vehicle information storage apparatus as follows. That is, the vehicle information storage apparatus includes: a state information acquisition means that acquires state information of a vehicle; a temporary storage means that temporarily stores therein the state information acquired by the state information acquisition means; a stipulation table storage means that stores therein a stipulation table that stipulates an information specification reference for specifying verification information, which is used for verification of a defect cause, out of the state information stored in the temporary storage means; and a control means that, based on the information specification reference stipulated in the stipulation table, specifies verification information used for verification of a defect cause from the state information stored in the temporary storage means, and causes a predetermined storage medium to store the specified verification information. On the stipulation table, defect detection by the user and a class and a range of the corresponding verification information are stipulated as the information specification reference. When defect detection by the user, which is stipulated in the stipulation table, is performed, the control means specifies the verification information of the corresponding class, which is stipulated in the stipulation table, within the range stipulated in the stipulation table, and causes the predetermined storage medium to store the verification information of the specified class and range.

### CITATION LIST

PATENT LITERATURE 1: Japanese Laid-Open Patent Publication No. 2008-216113
PATENT LITERATURE 2: Japanese Laid-Open Patent Publication No. 2014-081390

### SUMMARY OF THE INVENTION

A detection device according to the present disclosure includes: a first acquisition unit configured to acquire, from a vehicle, vehicle information regarding the vehicle, the vehicle information including identification information of the vehicle; a second acquisition unit configured to acquire a collection record of the vehicle information acquired by the first acquisition unit; a third acquisition unit configured to acquire an operation plan for the vehicle corresponding to the identification information; and a detection unit configured to detect an abnormality related to the vehicle, based on the collection record and the operation plan.

One mode of the present disclosure can be realized not only as a detection device that includes such a characteristic processing unit, but also as a semiconductor integrated circuit that realizes a part or the entirety of the detection device.

### BRIEF DESCRIPTION OF DRAWINGS

FIG. 1 shows a configuration of a communication system according to an embodiment of the present disclosure.

FIG. 2 shows a configuration of a detection device according to the embodiment of the present disclosure.

FIG. 3 shows an example of information that is used for abnormality detection by the detection device according to the embodiment of the present disclosure.

FIG. 4 shows an example of setting information and data collection estimates that are used for abnormality detection by the detection device according to the embodiment of the present disclosure.

FIG. 5 shows an example of a data collection plan table that is used for abnormality detection by the detection device according to the embodiment of the present disclosure.

FIG. 6 shows an example of a data collection record that is used for abnormality detection by the detection device according to the embodiment of the present disclosure.

FIG. 7 shows an example of types of abnormalities that are detected by the detection device according to the embodiment of the present disclosure.

FIG. 8 shows an example of a data collection record that is used for abnormality detection by modification 1 of the detection device according to the embodiment of the present disclosure.

FIG. 9 shows an example of transmission location information that is used for abnormality detection by modification 2 of the detection device according to the embodiment of the present disclosure.

FIG. 10 shows an example of list information that is created by modification 3 of the detection device according to the embodiment of the present disclosure.

FIG. 11 shows a configuration of modification 4 of the detection device according to the embodiment of the present disclosure.

FIG. 12 shows an example of a setting screen that is displayed by modification 4 of the detection device according to the embodiment of the present disclosure.

FIG. 13 shows an example of a monitoring screen that is displayed by modification 4 of the detection device according to the embodiment of the present disclosure.

FIG. 14 is a flowchart of an operation procedure when the detection device according to the embodiment of the present disclosure detects an abnormality in a vehicle.

FIG. 15 is a flowchart of an operation procedure when the detection device according to the embodiment of the present disclosure detects an abnormality in a vehicle.

FIG. 16 is a flowchart of an operation procedure when modification 3 of the detection device according to the embodiment of the present disclosure creates list information.

### DETAILED DESCRIPTION

To date, technologies for grasping malfunctions of vehicles have been developed.

### Problems to be Solved by the Present Disclosure

Grasping abnormalities related to vehicles from a viewpoint different from the technologies described in Patent Literatures 1 and 2 is useful in vehicle management.

The present disclosure has been made to solve the above problems, and an object of the present disclosure is to provide a detection device, a detection system, a detection method, and a detection program capable of easily grasping abnormalities related to vehicles.

### Effects of the Present Disclosure

According to the present disclosure, it is possible to easily grasp abnormalities related to vehicles.

### Description of Embodiment of the Present Disclosure

First, the contents of the embodiment of the present disclosure are listed and described.
(1) A detection device according to the embodiment of the present disclosure includes: a first acquisition unit configured to acquire, from a vehicle, vehicle information regarding the vehicle, the vehicle information including identification information of the vehicle; a second acquisition unit configured to acquire a collection record of the vehicle information acquired by the first acquisition unit; a third acquisition unit configured to acquire an operation plan for the vehicle corresponding to the identification information; and a detection unit configured to detect an abnormality related to the vehicle, based on the collection record and the operation plan.

Unlike devices installed in factories, etc., vehicles have periods when the vehicles do not transmit data even when they are in the normal state. Focusing on this point, in the configuration of detecting an abnormality based on the collection record of the vehicle information and the operation plan for the vehicle, it is possible to easily detect an abnormality related to data transmission of the vehicle by using a data collection record from the vehicle. This enables the user to easily grasp the abnormality related to the vehicle.
(2) In the above (1), the detection device may further include a fourth acquisition unit configured to acquire setting information indicating setting contents of the vehicle regarding transmission of the vehicle information. The detection unit may detect an abnormality related to the vehicle, based on the setting information, the collection record, and the operation plan.

In the configuration of detecting an abnormality by using the setting contents regarding transmission of the vehicle information by the vehicle, it is possible to grasp not only presence/absence of transmission of the vehicle information but also a more specific transmission state, whereby the abnormality in the vehicle can be more accurately detected.
(3) In the above (2), the setting information may include at least one of: a transmission cycle of the vehicle information by the vehicle; and the type of the vehicle information transmitted by the vehicle.

In the configuration of using the transmission cycle of the vehicle information for abnormality determination, it is possible to more easily determine the abnormality related to transmission of the vehicle information, based on the number of times of reception. Moreover, in the configuration of using the type of the vehicle information for abnormality determination, it is possible to determine, for example, whether the reason for the data amount being small is because communication between the vehicle and the detection device is unstable, or because vehicle information of a specific data type has not been uploaded.
(4) In the above (2) or (3), the setting information may include the type of the vehicle information transmitted by the vehicle. The detection device may further include a fifth acquisition unit configured to acquire transmission location information indicating correspondence between the type, and a location where the vehicle information is transmitted in the vehicle. When the detection unit has detected the abnormality, the detection unit may specify a location where the abnormality has occurred, based on the collection record, the type included in the setting information, and the transmission location information.

In the configuration of using the type of the vehicle information for abnormality determination, it is possible to determine, for example, whether the reason for the data amount being small is because communication between the vehicle and the detection device is unstable, or because vehicle information of a specific data type has not been uploaded. Moreover, since the collection record can be grasped for each type of vehicle information, the location where the abnormality has occurred in the vehicle can be specified, whereby the abnormality can be analyzed in more detail.
(5) In any one of the above (1) to (4), the operation plan may be divided into a plurality of time periods. The detection unit may determine, for each time period, whether or not a deviation between the operation plan and the collection record has occurred, and may detect the abnormality, based on occurrence frequency of the deviation in each of the plurality of time periods.

In the above configuration, it is possible to temporally analyze the abnormality in the vehicle in more detail, and it is possible to reduce the possibility of erroneous detection of an abnormality due to temporary driving conditions of the vehicle.
(6) In any of the above (1) to (5), the detection device may further include an analysis unit configured to calculate an index value of a deviation between the operation plan and the collection record, and to create, based on the index value, list information of the vehicles that require countermeasures against the abnormalities.

In the above configuration, it is possible to easily grasp a group of vehicles in which similar abnormalities occur, by sorting the vehicles with the index value, for example.
(7) In any one of the above (2) to (4), the setting information may include the type of the vehicle information to be transmitted by the vehicle, and the detection unit may perform a process of displaying, on a screen, a content based on the type of the vehicle information in which the abnormality has occurred.

In the above configuration, for example, when a malfunction has occurred in a retrofitted device of the vehicle that transmits the vehicle information, even an uninformed user can easily grasp an abnormality in the device. This makes it possible to efficiently distinguish the cause of the malfunction, and reduce the burden of the recall work for retrofitted devices, for example.
(8) A detection system according to the embodiment of the present disclosure includes an in-vehicle device mounted in a vehicle, and a detection device. The in-vehicle device transmits, to the detection device, vehicle information regarding the vehicle, the vehicle information including identification information of the vehicle. The detection device detects an abnormality related to the vehicle, based on a collection record of the vehicle information in the detection device, and an operation plan for the vehicle corresponding to the identification information.

Unlike devices installed in factories, etc., vehicles have periods when they do not transmit data even when they are in the normal state. Focusing on this point, in the configuration of detecting an abnormality based on the collection record of the vehicle information and the operation plan for the vehicle, it is possible to easily detect an abnormality related to data transmission of the vehicle by using a data collection record from the vehicle.

This enables the user to easily grasp the abnormality related to the vehicle.
(9) A detection method according to the embodiment of the present disclosure is a method used in a detection device, and the method includes: acquiring, from a vehicle, vehicle information regarding the vehicle, the vehicle information including identification information of the vehicle; acquiring a collection record of the vehicle information by the detection device; acquiring an operation plan for the vehicle corresponding to the identification information; and detecting an abnormality related to the vehicle, based on the collection record and the operation plan.

Unlike devices installed in factories, etc., vehicles have periods when they do not transmit data even when they are in the normal state. Focusing on this point, in the configuration of detecting an abnormality based on the collection record of the vehicle information and the operation plan for the vehicle, it is possible to easily detect an abnormality related to data transmission of the vehicle by using a data collection record from the vehicle. This enables the user to easily grasp the abnormality related to the vehicle.
(10) A detection program according to the embodiment of the present disclosure is a program used in a detection device, and the program causes a computer to function as: a first acquisition unit configured to acquire, from a vehicle, vehicle information regarding the vehicle, the vehicle information including identification information of the vehicle; a second acquisition unit configured to acquire a collection record of the vehicle information acquired by the first acquisition unit; a third acquisition unit configured to acquire an operation plan for the vehicle corresponding to the identification information; and a detection unit configured to detect an abnormality related to the vehicle, based on the collection record and the operation plan.

Unlike devices installed in factories, etc., vehicles have periods when they do not transmit data even when they are in the normal state. Focusing on this point, in the configuration of detecting an abnormality based on the collection record of the vehicle information and the operation plan for the vehicle, it is possible to easily detect an abnormality related to data transmission of the vehicle by using a data collection record from the vehicle. This enables the user to easily grasp the abnormality related to the vehicle.

Hereinafter, the embodiment of the present disclosure will be described with reference to the drawings. In the drawings, the same or corresponding parts are denoted by the same reference signs, and description thereof is not repeated. At least some parts of the embodiment described below can be combined together as desired.

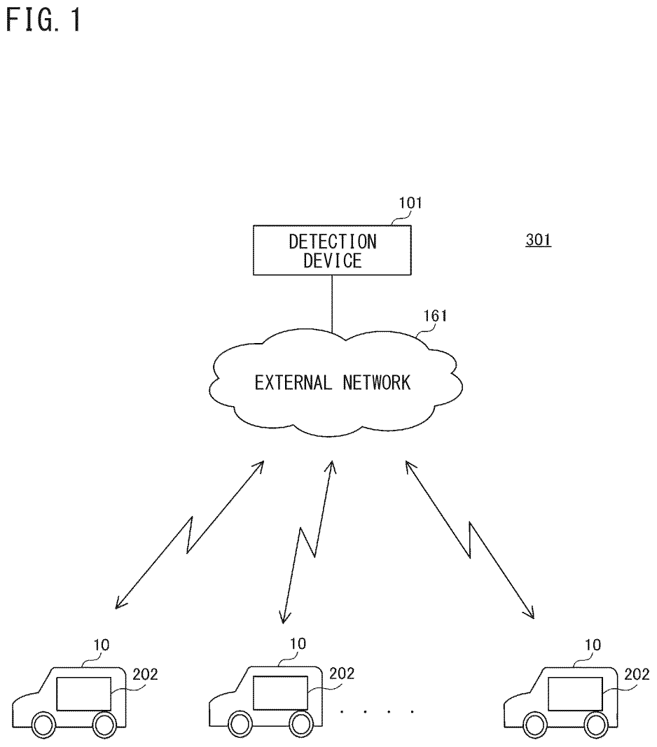

FIG. 1 shows a configuration of a communication system according to the embodiment of the present disclosure. With reference to FIG. 1, a communication system 301 includes a detection device 101, and one or more in-vehicle devices 202. The detection device 101 and each in-vehicle device 202 can exchange information via an external network 161 such as the Internet, for example. Each in-vehicle device 202 is mounted in a vehicle 10.

The detection device 101 is used by, for example, a business operator or an individual who manages the operation of the vehicle 10 (hereinafter, both are referred to as “user”).

The detection device 101 collects vehicle information regarding the corresponding vehicle 10 from the one or more in-vehicle devices 202. Then, the detection device 101 detects an abnormality related to the vehicle 10, such as a malfunction of the vehicle 10, based on the collected vehicle information.

The in-vehicle device 202 transmits, to the detection device 101, vehicle information regarding the vehicle 10 and including identification information of the vehicle 10. Specifically, for example, each in-vehicle device 202 receives positional information of the corresponding vehicle 10 from a GPS (Global Positioning System) receiver or the like (not shown) in the vehicle 10, and transmits vehicle information including the received positional information, and the ID and a data type of the vehicle 10, to the detection device 101 via the external network 161. The vehicle information may include, for example, a measurement result of a sensor mounted in the vehicle 10, or drive control information of braking operation, etc., in the vehicle 10, in addition to the positional information.

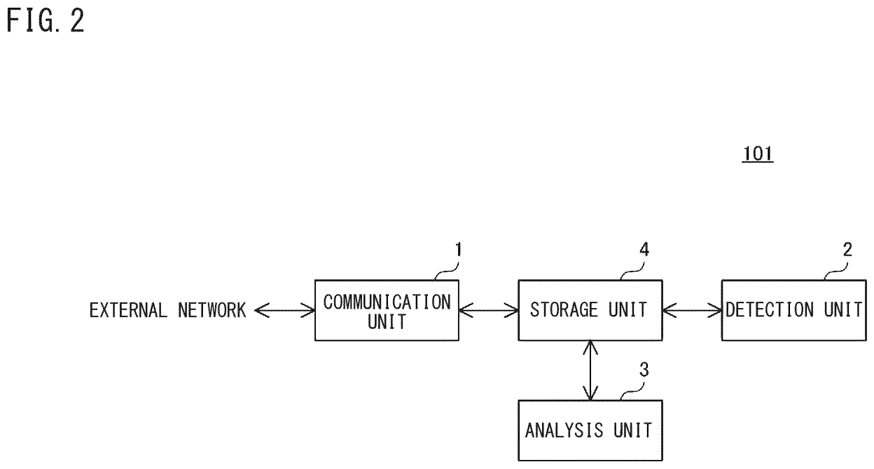

FIG. 2 shows a configuration of the detection device according to the embodiment of the present disclosure. With reference to FIG. 2, the detection device 101 includes a communication unit 1, a detection unit 2, an analysis unit 3, and a storage unit 4. Some or all of the communication unit 1, the detection unit 2, and the analysis unit 3 are implemented by, for example, processing circuitry including one or more processors. The storage unit 4 is, for example, a non-volatile memory included in the processing circuitry.

The communication unit 1 exchanges information with each in-vehicle device 202 via the external network 161. The communication unit 1 stores the information received from the in-vehicle device 202, in the storage unit 4.

The communication unit 1, as a first acquisition unit, acquires the vehicle information from the vehicle 10. More specifically, the communication unit 1 receives the vehicle information from the in-vehicle device 202, creates a communication log including the received vehicle information and a reception time of the vehicle information, and stores the communication log in the storage unit 4.

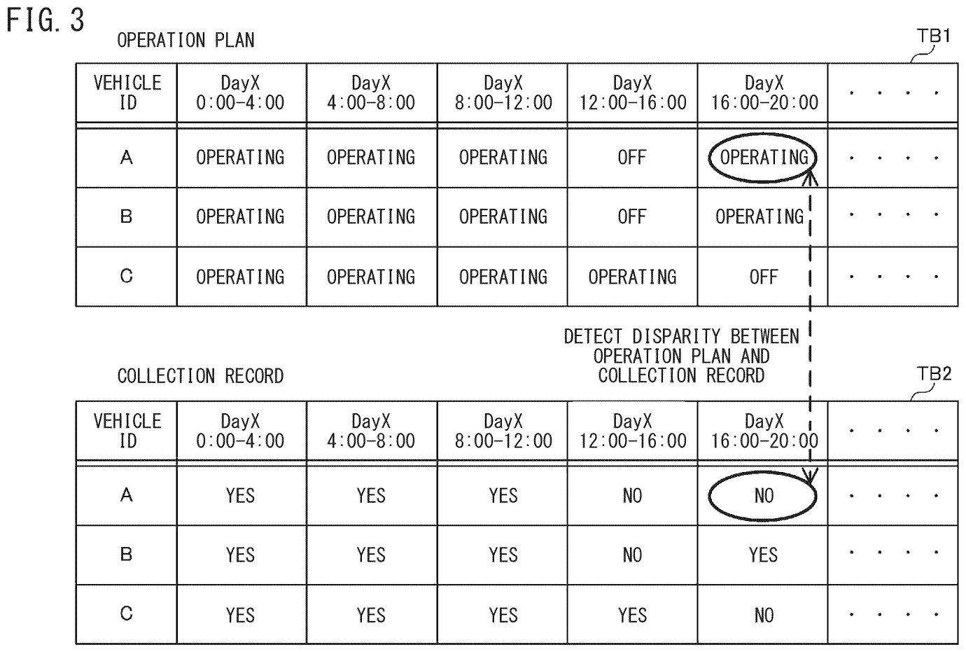

FIG. 3 shows an example of information that is used for abnormality detection by the detection device according to the embodiment of the present disclosure.

With reference to FIG. 3, the detection unit 2, as a third acquisition unit, acquires an operation plan for the vehicle 10 corresponding to the identification information included in the vehicle information acquired by the communication unit 1. More specifically, for example, the detection unit 2 acquires, from the storage unit 4, an operation plan table TB1 showing an operation plan for each vehicle 10. The operation plan table TB1 is registered in the storage unit 4 in advance by the user, for example. When a specific operation plan is not formulated, the operation plan table TB1 may be created based on the acquisition record of on and off states of an ignition power supply of the vehicle 10, for example.

The operation plan is divided into a plurality of time periods. In this example, the length of each time period is four hours. On the operation plan table TB1 for a certain day “Y” shown in FIG. 3, the operation plan of each of the vehicles 10 having the vehicle IDs of “A” and “B” is “operating” from 0:00 to 12:00, “off”from 12:00 to 16:00, and “operating” from 16:00 to 20:00. The operation plan of the vehicle 10 having the vehicle ID of “C” is “operating” from 0:00 to 16:00, and “off” from 16:00 to 20:00.

The analysis unit 3, as a second acquisition unit, acquires a collection record of vehicle information acquired by the first acquisition unit. More specifically, for example, the analysis unit 3 regularly or irregularly creates a collection record table TB2 showing the collection record of vehicle information for each vehicle 10, based on the communication log of vehicle information stored in the storage unit 4, and stores the collection record table TB2 in the storage unit 4.

The collection record is divided into a plurality of time periods. In this example, similarly to the operation plan, the length of each time period is four hours. On the collection record table TB2 for the certain day “X” shown in FIG. 3, the collection record of the vehicle 10 having the vehicle ID of “A” is “yes” from 0:00 to 12:00, and “no” from 12:00 to 20:00. The collection record of the vehicle 10 having the vehicle ID of “B” is “yes” from 0:00 to 12:00, “no” from 12:00 to 16:00, and “yes” from 16:00 to 20:00. The collection record of the vehicle 10 having the vehicle ID of “C” is “yes” from 0:00 to 16:00, and “no” from 16:00 to 20:00.

The detection unit 2 detects an abnormality related to the vehicle 10, based on the collection record and the operation plan. Specifically, although the operation plan for the vehicle ID of “A” is “operating” from 16:00 to 20:00. on the operation plan table TB1, the collection record for the vehicle ID of “A” is “no” from 16:00 to 20:00. on the collection record table TB2. Since there is a time period in which the vehicle information is not received from the vehicle 10 being operating, the detection unit 2 determines that an abnormality related to the vehicle 10 having the vehicle ID of “A” has occurred.

The detection unit 2 outputs the abnormality detection result. For example, the detection unit 2 stores the abnormality detection result into the storage unit 4, or notifies the user of the abnormality detection result.

### Another Example of Abnormality Detection

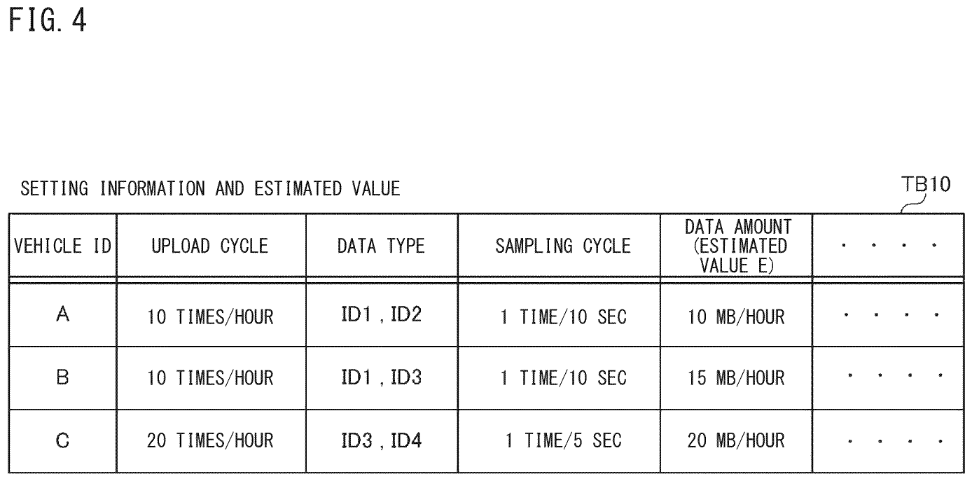

FIG. 4 shows an example of setting information and data collection estimates that are used for abnormality detection by the detection device according to the embodiment of the present disclosure.

With reference to FIG. 4, the analysis unit 3, as a fourth acquisition unit, acquires setting information indicating setting contents of the vehicle 10 regarding transmission of vehicle information. For example, the setting information includes the transmission cycle of the vehicle information by the vehicle 10, and the type of the vehicle information to be transmitted by the vehicle 10.

More specifically, the analysis unit 3 acquires, for each vehicle 10, setting contents of upload cycle, data type, and sampling cycle from the storage unit 4, and calculates an estimated value E of data amount per unit time of the vehicle information transmitted from the vehicle 10, based on the acquired upload cycle and sampling cycle, and on a predetermined data amount per sample of vehicle information. Then, the analysis unit 3 creates a transmission data table TB10 including the above-described setting contents and the estimated value E for each vehicle 10, and stores the transmission data table TB 10 in the storage unit 4. The analysis unit 3 may not necessarily calculate the estimated value E, and the data amount per unit time may be registered in the storage unit 4 as setting information.

On the transmission data table TB 10 shown in FIG. 4, the upload cycle of the vehicle 10 having the vehicle ID of “A” is 10 times per hour, vehicle information of data types “ID1” and “ID2” are uploaded, the sampling cycle, i.e., the vehicle information generation cycle, is 1 time per 10 seconds, and the estimated value E is 10 megabytes per hour. The upload cycle of the vehicle 10 having the vehicle ID of “B” is 10 times per hour, vehicle information of data types “ID1” and “ID3” are uploaded, the sampling cycle is 1 time per 10 seconds, and the estimated value E is 15 megabytes per hour. The upload cycle of the vehicle 10 having the vehicle ID of “C” is 20 times per hour, vehicle information of data types “ID3” and “ID4” are uploaded, the sampling cycle is 1 time per 5 seconds, and the estimated value E is 20 megabytes per hour.

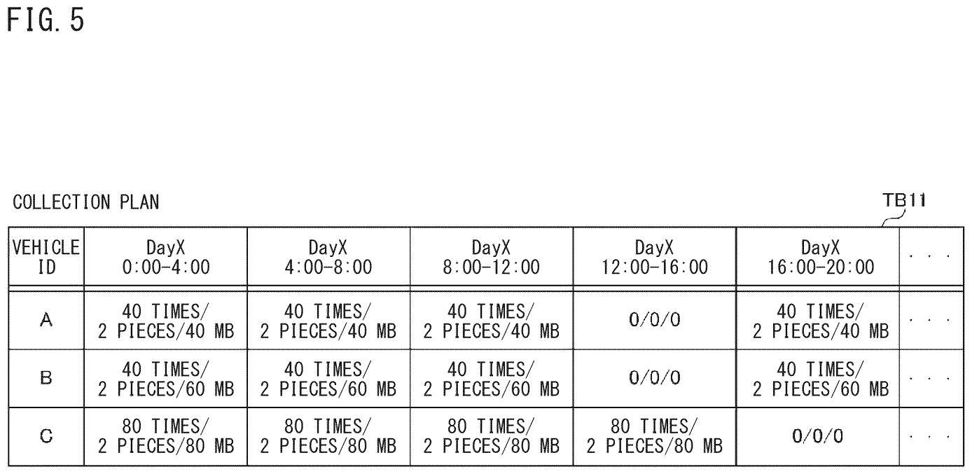

FIG. 5 shows an example of a data collection plan table used for abnormality detection by the detection device according to the embodiment of the present disclosure.

With reference to FIG. 5, the analysis unit 3 creates a collection plan for vehicle information from each vehicle 10, based on the setting information and the operation plan.

More specifically, based on the transmission data table TB10 and the operation plan table TB1 stored in the storage unit 4, the analysis unit 3 creates a data collection plan table TB11 showing a vehicle information collection plan for each vehicle 10, and stores the data collection plan table TB11 in the storage unit 4.

The data collection plan table TB11 shown in FIG. 5 shows “vehicle information upload cycle/data type/data amount to be uploaded” in each time period.

On the data collection plan table TB11 for the certain day “X”, the collection plan of the vehicle 10 having the vehicle ID of “A” is “40 times/2 pieces/40 megabytes” from 0:00 to 12:00, “0 times/0 pieces/0 megabytes” from 12:00 to 16:00, and “40 times/2 pieces/40 megabytes” from 16:00 to 20:00. The collection plan of the vehicle 10 having the vehicle ID of “B” is “40 times/2 pieces/60 megabytes” from 0:00 to 12:00, “0 times/0 pieces/0 megabytes” from 12:00 to 16:00, and “40 times/2 pieces/60 megabytes” from 16:00 to 20:00. The collection plan of the vehicle 10 having the vehicle ID of “C” is “80 times/2 pieces/80 megabytes” from 0:00 to 16:00, and “0 times/0 pieces/0 megabytes” from 16:00 to 20:00.

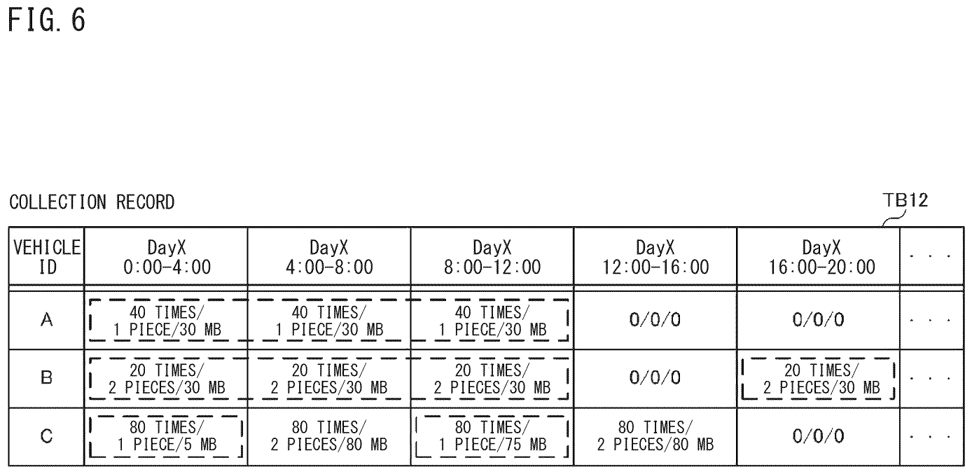

FIG. 6 shows an example of a data collection record used for abnormality detection by the detection device according to the embodiment of the present disclosure.

With reference to FIG. 6, the analysis unit 3, as the second acquisition unit, acquires a collection record of vehicle information acquired by the first acquisition unit. More specifically, the analysis unit 3 regularly or irregularly creates a collection record table TB12 showing the collection record of vehicle information for each vehicle 10, based on the communication log of vehicle information stored in the storage unit 4, and stores the collection record table TB2 in the storage unit 4.

The data collection plan table TB12 shown in FIG. 6 shows “vehicle information upload cycle/data type/data amount to be uploaded” in each time period, similarly to the data collection plan table TB11 shown in FIG. 5.

On the collection record table TB12 for the certain day “X”, the collection record of the vehicle 10 having the vehicle ID of “A” is “40 times/1 piece/30 megabytes” from 0:00 to 12:00, “0 times/0 pieces/0 megabytes” from 12:00 to 20:00. The collection record of the vehicle 10 having the vehicle ID of “B” is “20 times/2 pieces/30 megabytes” from 0:00 to 12:00, “0 times/0 pieces/0 megabytes” from 12:00 to 16:00, and “20 times/2 pieces/30 megabytes” from 16:00 to 20:00. The collection record of the vehicle 10 having the vehicle ID of “C” is “80 times/1 piece/5 megabytes” from 0:00 to 4:00, “80 times/2 pieces/80 megabytes” from 4:00 to 8:00, “80 times/1 piece/75 megabytes” from 8:00 to 12:00, “80 times/2 pieces/80 megabytes” from 12:00 to 16:00, and “0 times/0 pieces/0 megabytes” from 16:00 to 20:00.

Based on the setting information, the operation plan, and the collection record, the detection unit 2 detects an abnormality related to each vehicle 10. For example, the detection unit 2 compares the collection plan based on the setting information and the operation plan with the collection record, and detects an abnormality related to the vehicle 10, based on the comparison result. Specifically, the detection unit 2 performs detection of an abnormality by comparing the data collection plan table TB11 with the collection record table TB12.

For example, the detection unit 2 calculates an index value of a deviation between the collection record, and the collection plan based on the setting information and the operation plan, and detects an abnormality, based on the index value.

Specifically, assuming that the operation plan at time t is Pt, the data collection result at time t is Rt, and a threshold value is T, the detection unit 2 calculates Rt/Pt, and when Rt/Pt≤T, determines that the collected amount of vehicle information is small at time t. Rt/Pt is an example of the index value. The following description will be given with the threshold value T being assumed to be 50%, for example.

### Example 1 of Abnormality Determination Criterion

The detection unit 2 performs abnormality determination for each item in the above-described “vehicle information upload cycle/data type/data amount to be uploaded”. Specifically, for example, when “upload cycle Rt in collection record/upload cycle Pt in operation plan ≤0.5” is satisfied, the detection unit 2 determines that there is an abnormality.

The detection unit 2 may perform determination regarding “vehicle information upload cycle” and “data amount to be uploaded” for each data type, or a plurality of data types at a time.

### Example 2 of Abnormality Determination Criterion

The detection unit 2 performs abnormality determination for a combination of items in the above-described “vehicle information upload cycle/data type/data amount to be uploaded”. Specifically, for example, when “number Rt of data types in collection record/number Pt of data types in operation plan ≤0.5” and “data amount Rt in collection record/data amount Pt in operation plan ≤0.5” are satisfied, the detection unit 2 determines that there is an abnormality.

FIG. 6 shows the case where the detection unit 2 performs determination on a plurality of data types at a time as described above. In either case where the abnormality determination criterion is example 1 or example 2, the detection unit 2 determines that an abnormality occurs from 0:00 to 12:00 in the vehicle 10 having the vehicle ID of “A”, an abnormality occurs from 0:00 to 12:00 and an abnormality occurs from 16:00 to 20:00. in the vehicle 10 having the vehicle ID of “B”, and an abnormality occurs from 0:00 to 4:00 in the vehicle 10 having the vehicle ID of “C”.

In the case of using example 1 of abnormality determination criterion, the detection unit 2 determines that an abnormality occurs from 8:00 to 12:00 in the vehicle 10 having the vehicle ID of “C”. Meanwhile, in the case of using example 2 of abnormality determination criterion, the detection unit 2 determines that no abnormality occurs from 8:00 to 12:00 in the vehicle 10 having the vehicle ID of “C” because the “data amount to be uploaded” does not satisfy the condition.

As described above, the configuration using the index values can prevent erroneous detection of abnormalities in the state where the driver of the vehicle 10 is taking a temporary break and vehicle information is not transmitted, or the state where the vehicle 10 is traveling on a highway and vehicle information regarding an operation of hazard lights is not transmitted.

The data collection plan table TB11 and the collection record table TB12 may not necessarily include all of the vehicle information upload cycle, the data type, and the data amount, and may include some of the upload cycle, the data type, and the data amount. However, when the upload cycle is included, an abnormality regarding transmission of vehicle information can be more easily determined based on the number of times of reception.

Meanwhile, when the data type is included, it is possible to determine, for example, whether the reason for the data amount being small is because communication between the vehicle 10 and the detection device 101 is unstable, or because vehicle information of a specific data type has not been uploaded.

### Modification 1: Discrimination of Abnormality Type

The detection unit 2 may further discriminate the abnormality type by comparing the data collection plan table TB11 with the collection record table TB12.

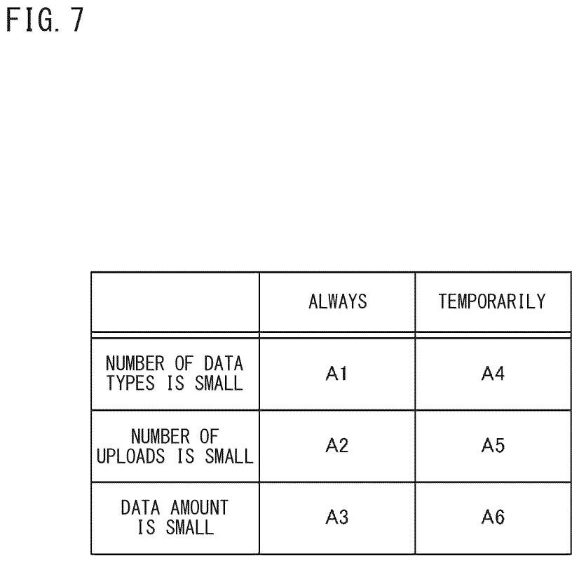

FIG. 7 shows an example of abnormality types detected by the detection device according to the embodiment of the present disclosure.

With reference to FIG. 7, the detection unit 2 can detect, for example, an abnormality A1 in which the number of data types of vehicle information from the vehicle 10 is always small, an abnormality A2 in which the number of uploads of vehicle information from the vehicle 10 is always small, an abnormality A3 in which the data amount of vehicle information from the vehicle 10 is always small, an abnormality A4 in which the number of data types of vehicle information from the vehicle 10 is temporarily small, an abnormality A5 in which the number of uploads of vehicle information from the vehicle 10 is temporarily small, and an abnormality A6 in which the data amount of vehicle information from the vehicle 10 is temporarily small.

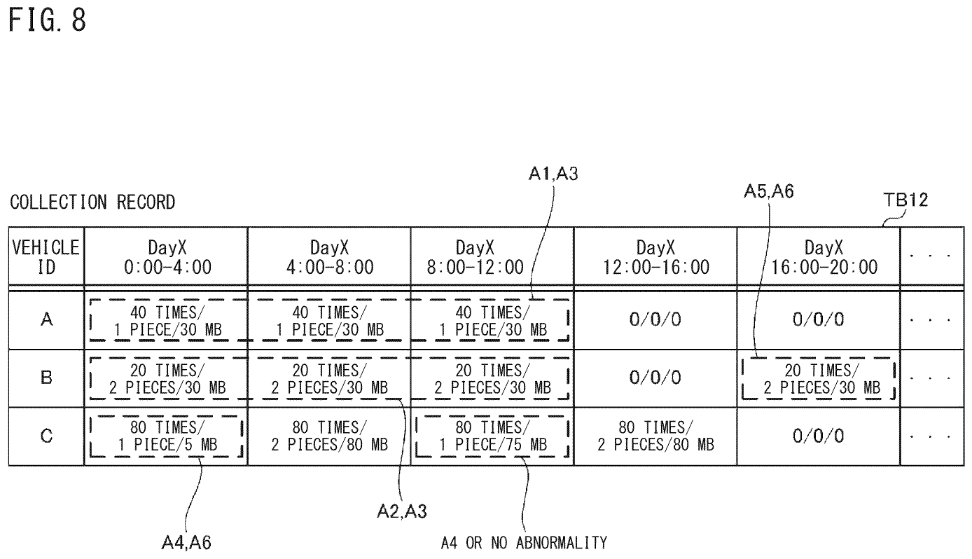

FIG. 8 shows an example of a data collection record used for abnormality detection by modification 1 of the detection device according to the embodiment of the present disclosure.

With reference to FIG. 8, for example, the detection unit 2 may determine, for each time period, whether or not a deviation has occurred between the operation plan and the collection record, and may detect an abnormality, based on the occurrence frequency of the deviation over a plurality of time periods.

More specifically, assuming that a threshold value for consecutive determination is N, when a time period in which Rt/Pt≤T is satisfied has occurred N times or more out of the most recent M times, the detection unit 2 determines that this case corresponds to “always” described with reference to FIG. 7. Here, M is an integer not less than 2, and N is an integer not larger than M and not less than 2.

In the example shown in FIG. 5 and FIG. 8, when M=3 and N=2, the detection unit 2 determines that abnormalities “always” occur in the vehicles 10 having the vehicle IDs of “A” and “B” from 0:00 to 12:00 on the certain day “X”. In addition, the detection unit 2 determines that an abnormality “temporarily” occurs from 16:00 to 20:00. in the vehicle 10 having the vehicle ID of “B”.

Moreover, the detection unit 2 determines that an abnormality “temporarily” occurs from 0:00 to 4:00, and from 8:00 to 12:00 in the vehicle 10 having the vehicle ID of “C”. As described above, in the case of using example 2 of abnormality determination criterion, the detection unit 2 may determine that no abnormality occurs from 8:00 to 12:00 in the vehicle 10 having the vehicle ID of “C”.

Moreover, for example, when a time period in which Rt/Pt≤T is satisfied continues a predetermined number of times or more, the detection unit 2 may determine that this case corresponds to “always” described with reference to FIG. 7.

FIG. 8 shows a case where the detection unit 2 determines a plurality of data types at a time. In either case where the abnormality determination criterion is example 1 or example 2, the detection unit 2 determines that abnormalities A1, A3 occur from 0:00 to 12:00 in the vehicle 10 having the vehicle ID of “A”, abnormalities A2, A3 occur from 0:00 to 12:00 and abnormalities A5, A6 occur from 16:00 to 20:00. in the vehicle 10 having the vehicle ID of “B”, and abnormalities A4, A6 occur from 0:00 to 4:00 in the vehicle 10 having the vehicle ID of “C”. In the case of using example 1 of abnormality determination criterion, the detection unit 2 determines that an abnormality A4 occurs from 8:00 to 12:00 in the vehicle 10 having the vehicle ID of “C”. Meanwhile, in the case of using example 2 of abnormality determination criterion, the detection unit 2 determines that no abnormality occurs from 8:00 to 12:00 in the vehicle 10 having the vehicle ID of “C”, because the data amount does not satisfy the condition.

The detection unit 2 may not necessarily determine whether the abnormality type is “always” or “temporarily” as described with reference to FIG. 7. For example, the detection unit 2 may determine that an abnormality occurs when a time period in which Rt/Pt≤T is satisfied has occurred N times or more out of the most recent M times, and may determine that no abnormality occurs when such a time period has occurred less than N times.

### Modification 2: Specifying Location of Abnormality

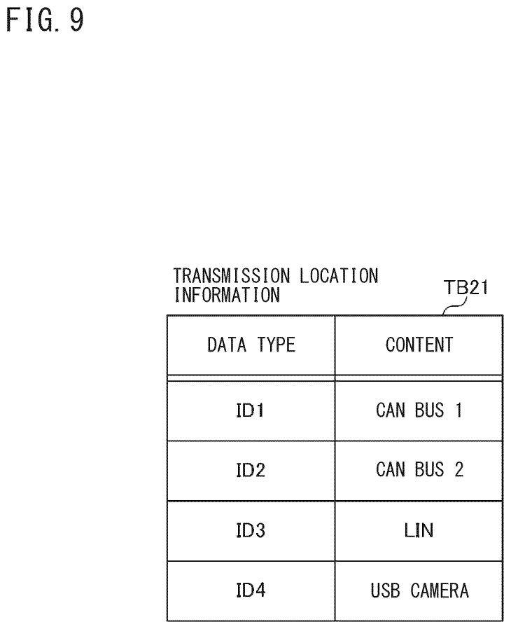

FIG. 9 shows an example of transmission location information used for abnormality detection by modification 2 of the detection device according to the embodiment of the present disclosure.

With reference to FIG. 9, the detection unit 2, as a fifth acquisition unit, acquires transmission location information indicating the correspondence between the type of vehicle information and the location in the vehicle 10.

Specifically, for example, the detection unit 2 acquires, from the storage unit 4, a transmission location table TB21 showing the correspondence between the data type and the vehicle information transmission location. The transmission location table TB21 is, for example, created for each vehicle model, and registered in the storage unit 4.

On the transmission location table TB21, vehicle information of data type “ID1” includes data to be transmitted on a CAN (Controller Area Network) bus 1, vehicle information of data type “ID2” includes data to be transmitted on a CAN bus 2, vehicle information of data type “ID3” includes data to be transmitted on a LIN (Local Interconnect Network), and vehicle information of data type “ID4” includes data to be outputted from a camera connected through a USB (Universal Serial Bus).

Upon detecting an abnormality, the detection unit 2 specifies the location where the abnormality has occurred, based on the collection record, the type included in the setting information, and the transmission location information.

Specifically, on the collection record table TB12 shown in FIG. 6, “vehicle information upload cycle/data type/data amount to be uploaded” being the collection record of the vehicle 10 having the vehicle ID of “A” is “40 times/1 piece/30 megabytes” from 0:00 to 12:00, and the number of data types and the data amount are less than those on the data collection plan table TB11 shown in FIG. 5. Therefore, the detection unit 2 refers to the setting contents of the communication log and the data type stored in the storage unit 4. For example, if the vehicle information of the data type “ID1” is not obtained from the vehicle 10 while the vehicle information of the data type “ID2” is obtained, the detection unit 2 determines that an abnormality occurs in the CAN bus 1 in the vehicle 10.

### Modification 3: Creation of List According to Index Value of Deviation

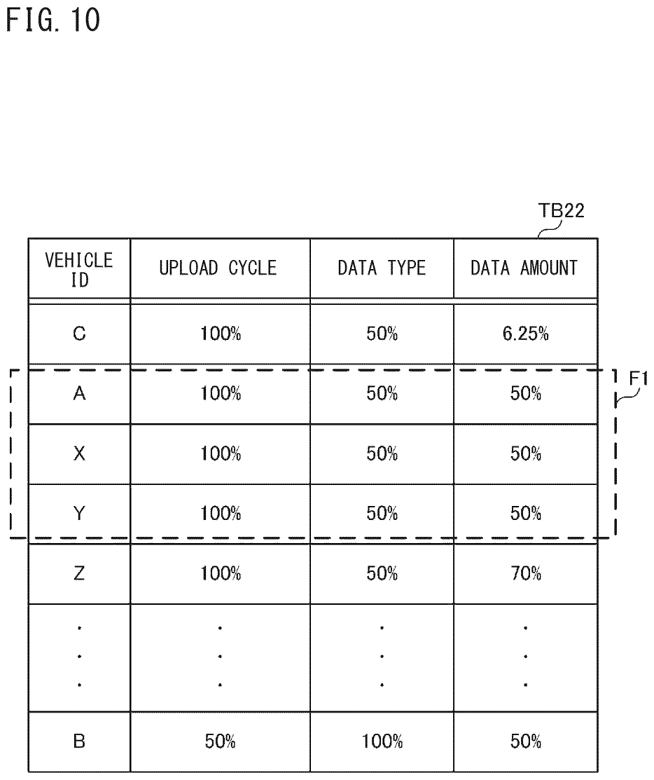

FIG. 10 shows an example of list information created by modification 3 of the detection device according to the embodiment of the present disclosure.

With reference to FIG. 10, the analysis unit 3 may calculate an index value of a deviation between the operation plan and the collection record, and may create list information of vehicles 10 that require countermeasures against abnormalities, based on the index value.

Specifically, the analysis unit 3 creates an index value table TB22 showing the index value of each vehicle 10 within a desired time period, and stores the index value table TB22 in the storage unit 4. For example, the detection unit 2 additionally registers the calculated Rt/Pt, in the collection record table TB12, in association with the vehicle ID and the time period on the collection record table TB12. The analysis unit 3 creates the index value table TB22 by using the index value Rt/Pt registered in the collection record table TB12 by the detection unit 2.

The index value table TB22 shown in FIG. 10 includes Rt/Pt of upload cycle, Rt/Pt of data type, and Rt/Pt of data amount for a time period from 0:00 to 4:00 on the certain day “X”, and is sorted in ascending order regarding the data type and the data amount.

This allows the user to easily grasp that similar abnormalities occur in the vehicles 10 having the vehicle IDs of “A”, “X”, and “Y” and surrounded by a frame F1.

### Modification 4: Presentation of Detection Result to User

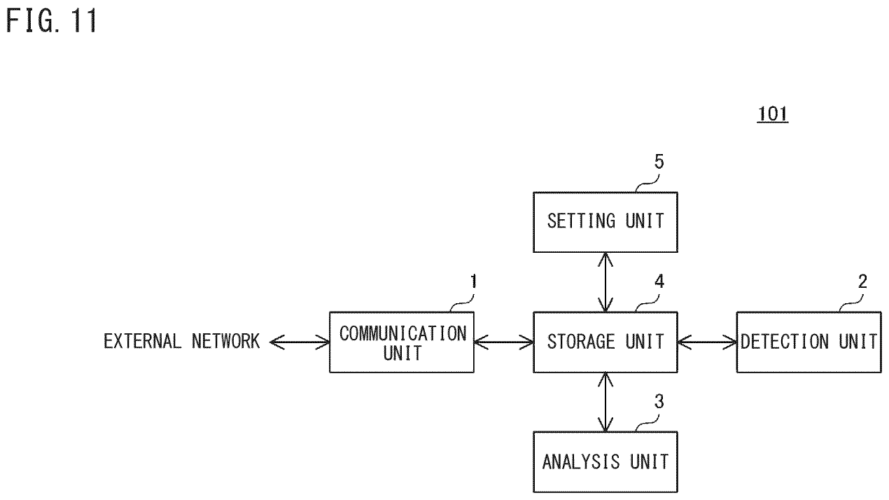

FIG. 11 shows a configuration of modification 4 of the detection device according to the embodiment of the present disclosure. With reference to FIG. 11, modification 4 of the detection device 101 further includes a setting unit 5, compared to the detection device 101 shown in FIG. 2. Some or all of the communication unit 1, the detection unit 2, the analysis unit 3, and the setting unit 5 are implemented by, for example, processing circuitry including one or more processors. The storage unit 4 is, for example, a non-volatile memory included in the processing circuitry.

The setting unit 5 creates setting information indicating setting contents of the vehicle 10 regarding transmission of vehicle information, based on an operation performed by the user, for example, and stores the setting information in the storage unit 4.

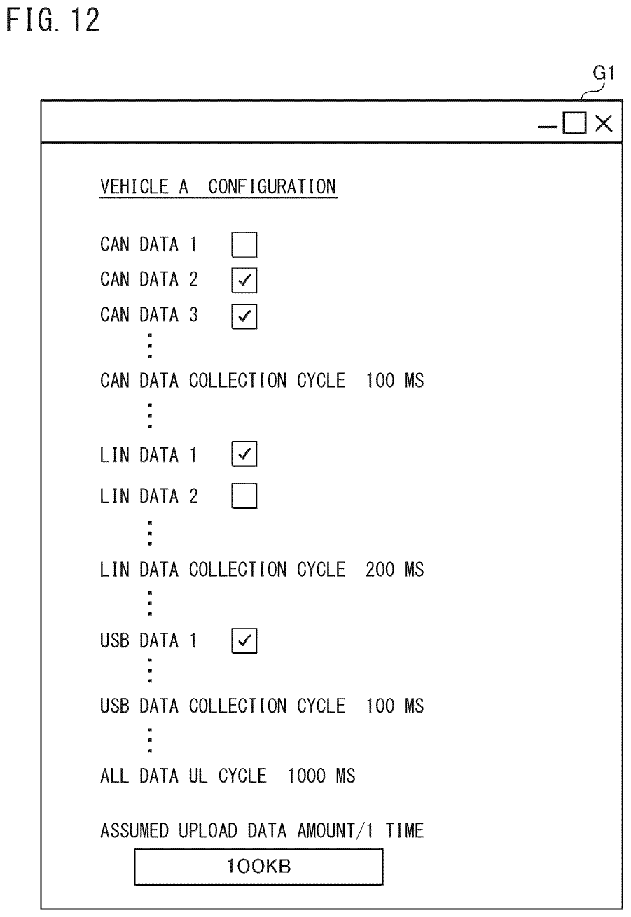

FIG. 12 shows an example of a setting screen that is displayed by modification 4 of the detection device according to the embodiment of the present disclosure.

With reference to FIG. 12, the setting unit 5 performs a process of creating a setting screen G1 for registering the contents of the setting information, and displays the setting screen G1 on a terminal device (not shown) such as a notebook PC (Personal Computer). More specifically, the setting unit S creates screen information indicating the setting screen G1, and transmits the screen information to the terminal device via the communication unit 1 and the external network 161. The terminal device displays the setting screen G1, based on the screen information received from the setting unit 5.

The setting screen G1 includes check boxes for inputting the data type of vehicle information to be acquired, and the data collection cycle for each data. In the example shown in FIG. 12, on the setting screen G1 showing the setting information of vehicle A, it is possible to select, for each bus, CAN data transmitted on the CAN bus, LIN data transmitted on the LIN bus, and USB data transmitted on the USB. It is also possible to input the data collection cycle for each data on the setting screen G1.

Specifically, according to an operation performed by the user, the terminal device transmits operation information to the detection device 101. The operation information indicates that CAN data 2, 3 are collected at a data collection cycle of 100 milliseconds, LIN data 2, 3 are collected at a data collection cycle of 200 milliseconds, USB data 1 is collected at a data collection cycle of 100 milliseconds, and all the data are collected at a data collection cycle of 1000 milliseconds.

The setting unit 5 creates setting information, based on the operation information received from the terminal device via the external network 161 and the communication unit 1, and stores the setting information in the storage unit 4. For example, when this setting information is registered in the in-vehicle device 202, the in-vehicle device 202 transmits the vehicle information to the detection device 101 according to the setting contents indicated by the setting information. For example, the setting information may be registered in the in-vehicle device 202 by the user, or may be transmitted to the in-vehicle device 202 and registered therein by the detection device 101.

Also, for example, the setting unit 5 performs a process of calculating an assumed amount of data to be uploaded from the vehicle A being the vehicle 10, based on the created setting information, and displaying the assumed amount of data on the setting screen G1. In the example shown in FIG. 12, the assumed amount of data of vehicle information, per upload, transmitted from the vehicle A is 100 kilobytes.

The terminal device may receive an operation to input the operation plan of the vehicle 10 by the user. In this case, the communication unit 1 receives operation information indicating the operation plan of the vehicle 10 from the terminal device, creates an operation plan table TB1 based on the received operation information, and stores the operation plan table TB1 in the storage unit 4.

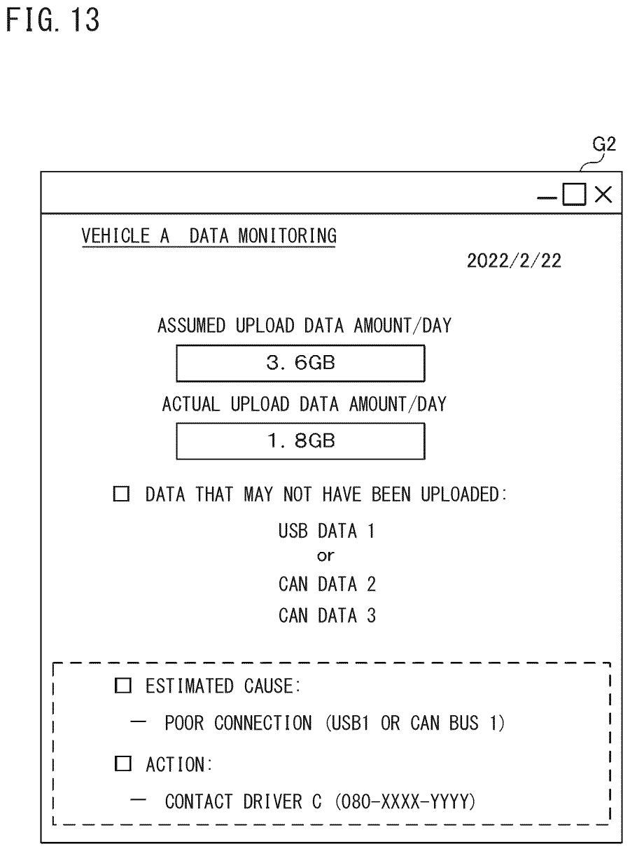

FIG. 13 shows an example of a monitoring screen that is displayed by modification 4 of the detection device according to the embodiment of the present disclosure.

With reference to FIG. 13, the detection unit 2 performs a process of displaying, on the screen, the content based on the type of vehicle information in which an abnormality has occurred.

More specifically, the detection unit 2 performs a process of: creating a monitoring screen G2 showing an abnormality detection result; creating screen information indicating the monitoring screen G2, similarly to the setting screen G1, for example; and transmitting the screen information to the terminal device to display the monitoring screen G2 on the terminal device.

The monitoring screen G2 includes: the date; the assumed amount of data to be uploaded, i.e., the amount of data of vehicle information per day assumed to be uploaded from the vehicle 10; the actual amount of uploaded data, i.e., the amount of data of vehicle information per day actually uploaded from the vehicle 10, and data that may not have been uploaded. The monitoring screen G2 further includes an estimated cause of the abnormality, and a proposed countermeasure against the abnormality.

In the example shown in FIG. 13, the monitoring screen G2, showing the monitoring result for the vehicle information from the vehicle A, displays that the assumed amount of data to be uploaded is 3.6 gigabytes, the amount of data actually uploaded is 1.8 gigabytes, and there is a possibility that the USB data 1 or the CAN data 2, 3 have not been uploaded. In addition, the monitoring screen G2 displays that the cause of the abnormality is poor connection in the USB 1 or the CAN bus 1, and that the driver C of the vehicle A should be contacted.

The detection unit 2 may display the assumed amount of data to be uploaded and the amount of data actually uploaded not per day but per hour, for example. The detection unit 2 may display the assumed amount of data to be uploaded and the amount of data actually uploaded for a period up to the current time point in a day.

When the detection unit 2 automatically notifies the driver C of the vehicle A in which an abnormality has occurred, of the abnormality detection result, the detection unit 2 may display, on the monitoring screen G2, a message indicating that the driver C of the vehicle A has been contacted, or that an abnormality lamp as equipment in the vehicle 10 has been turned on.

In the embodiment of the present disclosure including modification 4, the in-vehicle device 202 is, for example, a device that is retrofitted to the vehicle 10 after the vehicle 10 is shipped. Compared to existing devices, such a retrofitted device is expected to have various malfunctions caused by the retrofitted device. However, since the monitoring screen G2 is displayed as described above, when a malfunction has occurred in the retrofitted device, even an uninformed user can easily grasp the abnormality in the in-vehicle device 202. This makes it possible to efficiently distinguish the cause of the malfunction, and reduce the number of retrofitted devices to be recalled, for example, thereby reducing the burden of the recall work, etc.

### Operation Flow

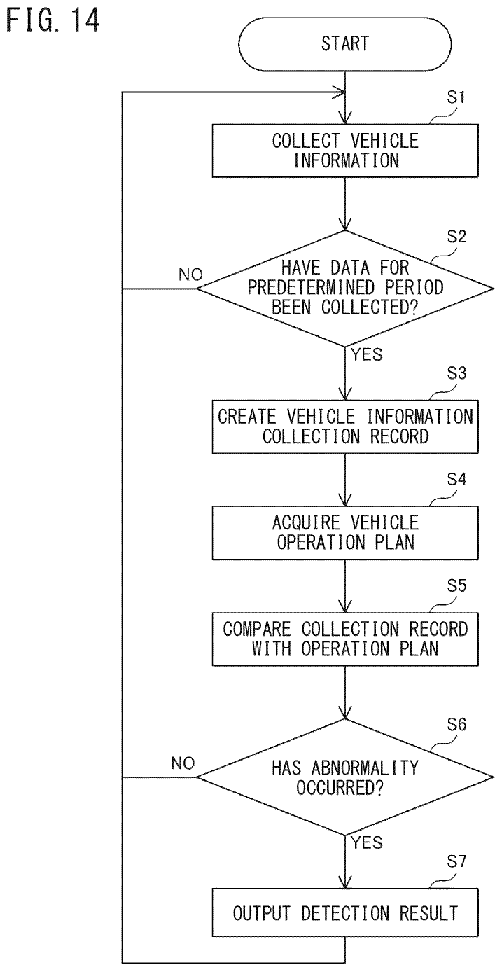

FIG. 14 is a flowchart of an operation procedure when the detection device according to the embodiment of the present disclosure detects an abnormality in a vehicle. FIG. 14 shows the process described with reference to FIG. 3.

With reference to FIG. 14, firstly, the detection device 101 collects vehicle information from one or more vehicles 10, and creates and stores communication logs (step S1).

Next, the detection device 101 continues collecting vehicle information until data for a predetermined period is collected (NO in step S2). When data for the predetermined period has been collected (YES in step S2), the detection device 101 creates the collection record table TB2 showing the collection record of the vehicle information (step S3).

Next, the detection device 101 acquires, from the storage unit 4, the operation plan table TB1 showing the operation plan of a vehicle 10 (step S4), and compares the collection record table TB2 with the operation plan table TB1 to detect an abnormality (step S5).

Upon determining that no abnormality has occurred (NO in step S6), the detection device 101 continues collecting vehicle information (step S1).

Upon determining that an abnormality has occurred (YES in step S6), the detection device 101 outputs the detection result (step S7), and continues collecting vehicle information (step S1).

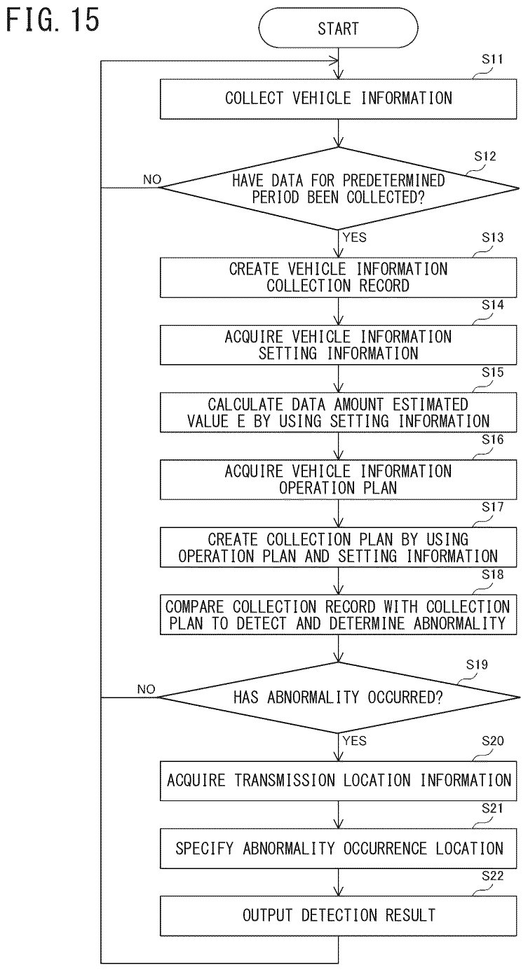

FIG. 15 is a flowchart of an operation procedure when the detection device according to the embodiment of the present disclosure detects an abnormality in a vehicle. FIG. 15 shows another example of the above-described abnormality detection. FIG. 15 also includes the processes of modifications 1, 2.

With reference to FIG. 15, firstly, the detection device 101 collects vehicle information from one or more vehicles 10, and creates and stores communication logs (step S11).

Next, the detection device 101 continues collecting vehicle information until data for a predetermined period is collected (NO in step S12). When data for the predetermined period has been collected (YES in step S12), the detection device 101 creates the collection record table TB12 showing the vehicle information collection record (step S13).

Next, the detection device 101 acquires the setting information from the storage unit 4 (step S14), and calculates an estimated value E of the amount of data, based on the setting information (step S15).

Next, the detection device 101 acquires, from the storage unit 4, the operation plan table TB1 showing the operation plan of the vehicle 10 (step S16), and creates the data collection plan table TB11 showing the collection plan for the vehicle information from the vehicle 10, based on the operation plan and the setting information, specifically, based on the operation plan table TB1 and the transmission data table TB10 (step S17).

Next, the detection device 101 compares the collection record table TB12 with the data collection plan table TB11 to detect an abnormality and determine the type of the abnormality (step S18).

Upon determining that no abnormality has occurred (NO in step S19), the detection device 101 continues collecting vehicle information (step S11).

Upon determining that an abnormality has occurred (YES in step S19), the detection device 101 acquires, from the storage unit 4, the transmission location table TB21 showing the transmission location of the vehicle information (step S20), and specifies the location where the abnormality has occurred, based on the setting contents of the data types indicated on the collection record table TB 12 and the transmission data table TB10, and the transmission location table TB21 (step S21).

Next, the detection device 101 outputs the detection result indicating, for example, the type of the abnormality and the location where the abnormality has occurred (step S22), and continues collecting vehicle information (step S11). The detection device 101 may perform a process of displaying the above-described monitoring screen G2 (step S22).

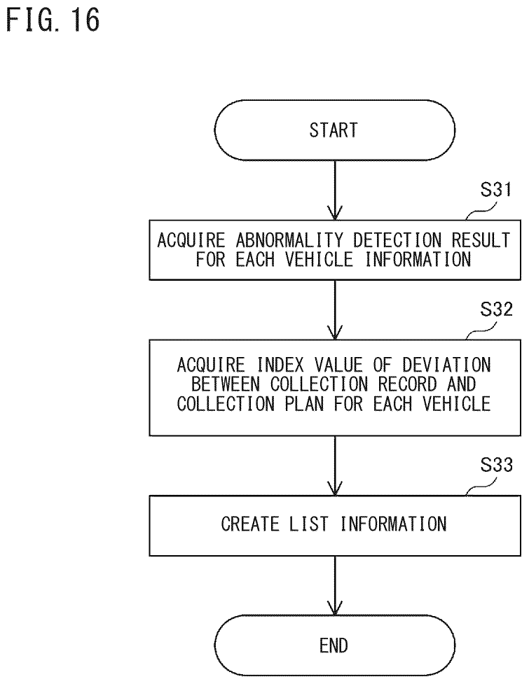

FIG. 16 is a flowchart of an operation procedure when modification 3 of the detection device according to the embodiment of the present disclosure creates list information.

With reference to FIG. 16, firstly, the detection device 101 acquires, from the storage unit 4, the abnormality detection result of each vehicle 10 (step S31).

Next, the detection device 101 acquires, from the collection record table TB12 in the storage unit 4, for example, the index value Rt/Pt of a deviation between the collection record, and the collection plan based on the operation plan, for each vehicle 10 in which an abnormality has occurred (step S32).

Next, using the index value Rt/Pt in the collection record table TB12, the detection device 101 creates the list information, e.g., the index value table TB22 as shown in FIG. 10, for example, and stores the list information in the storage unit 4 (step S33).

A part or the entirety of the functions of the detection device 101 may be provided by cloud computing. That is, the detection device according to the embodiment of the present disclosure may be a cloud server implemented by a plurality of servers.

The processes (functions) of the above-described embodiments may be realized by processing circuitry including one or more processors. In addition to the one or more processors, the processing circuitry may include an integrated circuit or the like in which one or more memories, various analog circuits, and various digital circuits are combined. The one or more memories have, stored therein, programs (instructions) that cause the one or more processors to execute the processes. The one or more processors may execute the processes according to the program read out from the one or more memories, or may execute the processes according to a logic circuit designed in advance to execute the processes. The above processors may include a CPU (Central Processing Unit), a GPU (Graphics Processing Unit), a DSP (Digital Signal Processor), an FPGA (Field Programmable Gate Array), an ASIC (Application Specific Integrated Circuit), etc., which are compatible with computer control. The physically separated processors may execute the processes in cooperation with each other. For example, the processors installed in physically separated computers may execute the processes in cooperation with each other through a network such as a LAN (Local Area Network), a WAN (Wide Area Network), or the Internet. The program may be installed in the memory from an external server device or the like through the network. Alternatively, the program may be distributed in a state of being stored in a recording medium such as a CD-ROM (Compact Disc Read Only Memory), a DVD-ROM (Digital Versatile Disk Read Only Memory), or a semiconductor memory, and may be installed in the memory from the recording medium.

The above-described embodiment is illustrative in all aspects and should be considered not restrictive. The scope of the present invention is not limited by the configuration of the above-described embodiment but is defined by the claims, and is intended to include meaning equivalent to the scope of the claims and all modifications within the scope.

The above description includes the features in the additional notes below.

### Additional Note 1

A detection device, including:
a first acquisition unit configured to acquire, from a vehicle, vehicle information regarding the vehicle, and including identification information of the vehicle;
a second acquisition unit configured to acquire a collection record of the vehicle information acquired by the first acquisition unit;
a third acquisition unit configured to acquire an operation plan for the vehicle corresponding to the identification information; and
a detection unit configured to detect an abnormality related to the vehicle, based on the collection record and the operation plan,
the detection device further including an analysis unit configured to create a collection plan for the vehicle information, based on the setting information and the operation plan, wherein
the detection unit compares the collection plan with the collection record, and detects an abnormality related to the vehicle, based on a result of the comparison.

### Additional Note 2

A detection device including processing circuitry,
the processing circuitry being configured to:
acquire, from a vehicle, vehicle information regarding the vehicle, and including identification information of the vehicle;
acquire a collection record of the vehicle information by a first acquisition unit;
acquire an operation plan for the vehicle corresponding to the identification information; and
detect an abnormality related to the vehicle, based on the collection record and the operation plan.

### REFERENCE SIGNS LIST

1 communication unit
2 detection unit
3 analysis unit
4 storage unit
5 setting unit
10 vehicle
102 in-vehicle device
161 external network
202 in-vehicle device
301 communication system
A1, A2, A3, A4, A5, A6 abnormality
F1 frame
TB1 operation plan table
TB10 transmission data table
TB11 data collection plan table
TB2, 12 collection record table
TB21 transmission location table
TB22 index value table

1. A detection device comprising a processor programmed to perform operations comprising:
acquiring, from a vehicle, vehicle information regarding the vehicle, the vehicle information including identification information of the vehicle;
acquiring a collection record of the vehicle information;
acquiring an operation plan for the vehicle corresponding to the identification information; and
detecting an abnormality related to the vehicle, based on the collection record and the operation plan.

2. The detection device according to claim 1, wherein
the operations further comprise acquiring setting information indicating setting contents of the vehicle regarding transmission of the vehicle information, and
the detecting includes detecting an abnormality related to the vehicle, based on the setting information, the collection record, and the operation plan.

3. The detection device according to claim 2, wherein
the setting information includes at least one of: a transmission cycle of the vehicle information by the vehicle; and a type of the vehicle information transmitted by the vehicle.

4. The detection device according to claim 2, wherein
the setting information includes the type of the vehicle information transmitted by the vehicle,
the operations further comprises acquiring transmission location information indicating correspondence between the type, and a location where the vehicle information is transmitted in the vehicle, and
when the abnormality has been detected, the detecting includes specifying a location where the abnormality has occurred, based on the collection record, the type included in the setting information, and the transmission location information.

5. The detection device according to claim 1, wherein
the operation plan is divided into a plurality of time periods, and
the detecting includes determining, for each time period, whether or not a deviation between the operation plan and the collection record has occurred, and detecting the abnormality, based on occurrence frequency of the deviation in each of the plurality of time periods.

6. The detection device according to claim 1, wherein
the operations further comprise calculating an index value of a deviation between the operation plan and the collection record, and creating, based on the index value, list information of the vehicles that require countermeasures against the abnormalities.

7. The detection device according to claim 2, wherein
the setting information includes the type of the vehicle information to be transmitted by the vehicle, and
the detecting includes performing a process of displaying, on a screen, a content based on the type of the vehicle information in which the abnormality has occurred.

8. A detection system, comprising:
an in-vehicle device mounted in a vehicle; and
a detection device, wherein
the in-vehicle device transmits, to the detection device, vehicle information regarding the vehicle, the vehicle information including identification information of the vehicle, and
the detection device detects an abnormality related to the vehicle, based on a collection record of the vehicle information in the detection device, and an operation plan for the vehicle corresponding to the identification information.

9. A detection method used in a detection device, the method comprising:
acquiring, from a vehicle, vehicle information regarding the vehicle, the vehicle information including identification information of the vehicle;
acquiring a collection record of the vehicle information by the detection device;
acquiring an operation plan for the vehicle corresponding to the identification information; and
detecting an abnormality related to the vehicle, based on the collection record and the operation plan.

10. A non-transitory computer-readable storage medium in which a detection program used in a detection device is stored, the program causing a computer to function as:
a first acquisition unit configured to acquire, from a vehicle, vehicle information regarding the vehicle, the vehicle information including identification information of the vehicle;
a second acquisition unit configured to acquire a collection record of the vehicle information by the first acquisition unit;
a third acquisition unit configured to acquire an operation plan for the vehicle corresponding to the identification information; and
a detection unit configured to detect an abnormality related to the vehicle, based on the collection record and the operation plan.

11. The detection device according to claim 3, wherein
the setting information includes the type of the vehicle information transmitted by the vehicle, and
the operations further comprise acquiring transmission location information indicating correspondence between the type, and a location where the vehicle information is transmitted in the vehicle, and
when the abnormality has been detected, the detecting includes specifying a location where the abnormality has occurred, based on the collection record, the type included in the setting information, and the transmission location information.

12. The detection device according to claim 2, wherein
the operation plan is divided into a plurality of time periods, and
the detecting includes determining, for each time period, whether or not a deviation between the operation plan and the collection record has occurred, and detecting the abnormality, based on occurrence frequency of the deviation in each of the plurality of time periods.

13. The detection device according to claim 3, wherein
the operation plan is divided into a plurality of time periods, and
the detecting includes determining, for each time period, whether or not a deviation between the operation plan and the collection record has occurred, and detecting the abnormality, based on occurrence frequency of the deviation in each of the plurality of time periods.

14. The detection device according to claim 4, wherein
the operation plan is divided into a plurality of time periods, and
the detecting includes determining, for each time period, whether or not a deviation between the operation plan and the collection record has occurred, and detecting the abnormality, based on occurrence frequency of the deviation in each of the plurality of time periods.

15. The detection device according to claim 2, wherein
the operations further comprise calculating an index value of a deviation between the operation plan and the collection record, and creating, based on the index value, list information of the vehicles that require countermeasures against the abnormalities.

16. The detection device according to claim 3, wherein
the operations further comprise calculating an index value of a deviation between the operation plan and the collection record, and creating, based on the index value, list information of the vehicles that require countermeasures against the abnormalities.

17. The detection device according to claim 4, wherein
the operations further comprise calculating an index value of a deviation between the operation plan and the collection record, and creating, based on the index value, list information of the vehicles that require countermeasures against the abnormalities.

18. The detection device according to claim 5, wherein
the operations further comprise calculating an index value of a deviation between the operation plan and the collection record, and creating, based on the index value, list information of the vehicles that require countermeasures against the abnormalities.

19. The detection device according to claim 3, wherein
the setting information includes the type of the vehicle information to be transmitted by the vehicle, and
the detecting includes performing a process of displaying, on a screen, a content based on the type of the vehicle information in which the abnormality has occurred.

20. The detection device according to claim 4, wherein
the setting information includes the type of the vehicle information to be transmitted by the vehicle, and
the detecting includes performing a process of displaying, on a screen, a content based on the type of the vehicle information in which the abnormality has occurred.
